(19) United States
(12) Patent Application Publication
(10) Pub. No.: US 2026/0260172 A1
(43) Pub. Date: Sep. 3, 2026

(54) Context-Aware Associative Learning System for Deterministic Decision Governance with Outcome-Bound Association Updates and Replay Correction

(71) Applicant: Gregg Dotoli, Millsboro, DE (US)

(72) Inventor: Gregg Dotoli, Millsboro, DE (US)

(21) Appl. No.: 19/659,436

(22) Filed: Apr. 27, 2026

(51) Int. Cl. G06N 20/00

(52) U.S. Cl. CPC G06N 20/00

(57) ABSTRACT

A system and method for improving decision accuracy in autonomous systems by encoding context, associating prior cases, updating associations using outcome-derived evidence, detecting environmental drift, and replaying decisions to improve performance under uncertainty.

### FIELD OF THE INVENTION

The present invention relates to artificial intelligence systems, autonomous agents, and decision-support architectures. More specifically, the invention relates to systems and methods for improving decision accuracy under conditions of uncertainty, incomplete context, and environmental drift.

### BACKGROUND OF THE INVENTION

Existing artificial intelligence and autonomous decision systems rely primarily on statistical inference, pattern recognition, and heuristic-based logic. While effective in stable and well-defined environments, such systems exhibit significant limitations when operating under conditions of uncertainty, incomplete information, and dynamic environmental change.

These systems typically lack structured mechanisms for encoding situational context, resulting in an inability to distinguish between routine patterns and rare high-risk events. Additionally, current systems do not consistently bind decisions to real-world outcomes, limiting their ability to learn from prior decisions and improve performance over time.

As a result, known failure modes include misclassification under environmental drift, low-confidence dismissal of high-risk signals, and overconfidence in decisions made using incomplete or ambiguous data. Existing approaches, including reinforcement learning systems, graph-based models, and observability frameworks, do not provide a unified architecture that enforces context-aware decision-making, outcome-driven association updates, and replay-based correction.

Accordingly, there exists a need for a system that improves decision integrity by explicitly encoding context, weighting associations based on outcome evidence, detecting drift, and enabling continuous improvement through structured replay of prior decisions.

### SUMMARY OF THE INVENTION

The present invention provides a Context-Aware Associative Learning System (CALS), a deterministic system for improving decision accuracy in autonomous and artificial intelligence systems.

In one embodiment, the system encodes events into structured context objects that capture relevant situational attributes, assumptions, and confidence levels. The system associates current context objects with prior context objects using an association graph and assigns weights to these associations based on outcome-derived evidence.

A drift detection mechanism evaluates deviations between current context and previously observed patterns, adjusting the influence of historical associations when environmental changes are detected. Decisions are generated using weighted associations subject to deterministic constraints, including context completeness and confidence thresholds.

An outcome binding layer records expected and actual outcomes of decisions, enabling the system to update association weights based on outcome reliability. A replay engine re-evaluates prior decisions using updated information to improve future decision accuracy.

The invention reduces misclassification under drift, improves handling of uncertainty, and provides an auditable and continuously improving decision framework.

### BRIEF DESCRIPTION OF THE DRAWINGS

FIG. 1 illustrates the overall architecture of the Context-Aware Associative Learning System.

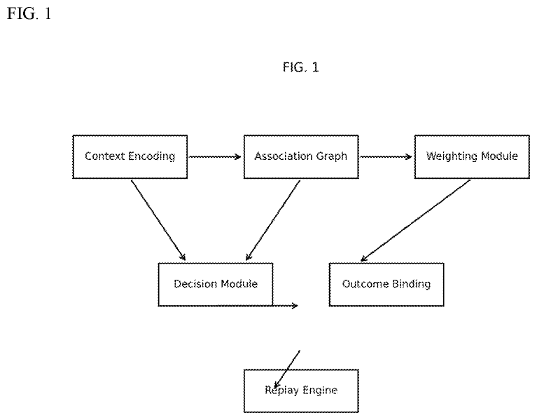

FIG. 2 illustrates the structure of a context object.

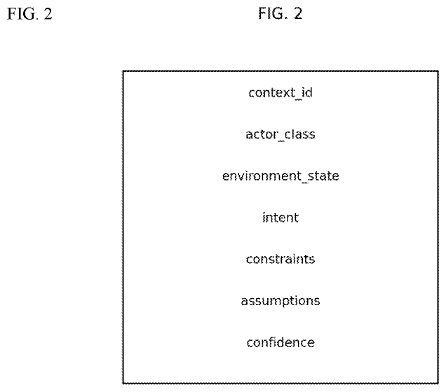

FIG. 3 illustrates the decision and replay flow.

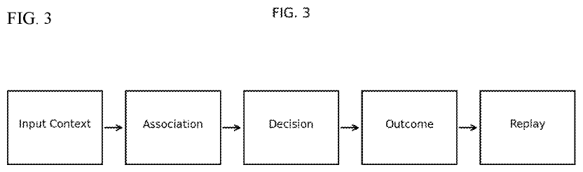

### DETAILED DESCRIPTION OF THE INVENTION

### Context Object Model

In one embodiment, each event is encoded into a structured context object comprising a unique identifier, actor classification, environmental state representation, inferred intent, constraint set, explicit assumptions with associated confidence weights, an overall confidence score, and a timestamp.

The system enforces context completeness, such that required fields must be present prior to decision execution. If context is incomplete, the system may delay decision-making, request additional information, or escalate the decision.

### Association Memory Graph

Context objects are stored and linked within an association memory graph. Relationships between context objects are established based on similarity, temporal proximity, co-occurrence, and validated causal relationships.

Each association includes a weight, an evidence count, an outcome score, and a decay factor. These associations enable the system to reference prior contexts when evaluating new events.

### Causal Weight Registry

Association weights are managed by a causal weight registry that updates weights based on outcome-derived evidence. Weight updates consider outcome reliability, evidence count, and recency.

Outcome reliability may include confirmed outcomes, partially verified outcomes, and inferred outcomes. Association weights are increased only when supported by validated outcome data.

### Outcome Binding Layer

Each decision is bound to outcome data, including an expected outcome, an actual observed outcome, an error magnitude, and a time-to-outcome measure.

This binding enables the system to evaluate decision accuracy and update association weights accordingly.

### Drift Detection Engine

The system includes a drift detection engine that evaluates deviations between current context and known context patterns. Contexts are classified as known, edge, or novel based on similarity thresholds.

When drift is detected, the system reduces reliance on historical associations and may escalate decisions or request additional information.

### Decision Replay Engine

The decision replay engine re-evaluates prior decisions using updated association weights and outcome data. Replay produces a decision delta and an improvement score, enabling continuous refinement of decision logic.

### Decision Function

Decisions are generated using a weighted evaluation of associated context objects:
Score(C)=SUM [Wi×Similarity(C, Ai)×OutcomeScorei×(1−DriftFactor)]

Decision generation is subject to deterministic constraints, including context completeness, explicit assumptions, and confidence thresholds.

### EXAMPLE SCENARIO

In one embodiment, the system is applied to a security monitoring environment. An agent detects outbound activity from a service account to an external endpoint. Context is incomplete, and confidence is low.

The system identifies a rare prior pattern associated with a security breach and detects environmental drift due to recent system changes. Instead of defaulting to low priority, the system escalates the decision.

Outcome data is recorded, and replay improves future classification accuracy.

1. A computer-implemented method for improving decision accuracy, comprising: encoding an event into a structured context object; associating the context object with prior context objects;
weighting associations based on outcome-derived evidence; generating a decision based on weighted associations; recording an expected outcome; receiving an actual outcome; updating association weights based on outcome reliability; and replaying prior decisions to improve future decisions.

2. The method of claim 1, wherein association weights decay over time based on a decay factor.

3. The method of claim 1, wherein the system enforces a context completeness constraint that blocks decision generation when required contextual attributes are missing.

4. The method of claim 1, wherein low-confidence decisions trigger escalation or request for additional information.

5. The method of claim 1, wherein association weights are updated using a confidence-weighted update mechanism based on outcome reliability.

6. A system comprising: a context encoding module; an association graph module; a weighting module; a decision module; an outcome binding module; a drift detection module; and a replay module configured to improve decision accuracy.

7. The system of claim 6, wherein the drift detection module classifies contexts as known, edge, or novel based on deviation thresholds.

8. The system of claim 6, wherein the replay module generates a decision delta and an improvement score based on comparison between original and replayed decisions.

9. The method of claim 1, wherein rare-event associations are weighted higher than frequent associations when outcome risk exceeds a defined threshold.
